(19) United States
(12) Patent Application Publication
(10) Pub. No.: US 2025/0389679 A1
(43) Pub. Date: Dec. 25, 2025

(54) AUTOMATED METHOD OF EVALUATING CANDLE BURN PERFORMANCE

(71) Applicant: Premier Candle Corporation, Mississauga, Ontario (CA)

(72) Inventors: Joanne Lee, Mississauga, Ontario (CA); Burjis K. Mehta, Mississauga, Ontario (CA)

(21) Appl. No.: 18/849,256

(22) PCT Filed: Sep. 18, 2024
(86) PCT No.: PCT/CA2024/051238

§ 371 Date: Sep. 20, 2024

Related U.S. Application Data
(60) Provisional application No. 63/599,213, filed on Nov. 15, 2023.

(51) Int. Cl. G01N 25/22; B65G 1/04; G06T 7/60; G06T 7/73; H04N 23/695

(52) U.S. Cl. CPC G01N 25/22; B65G 1/04; G06T 7/60; G06T 7/74; H04N 23/695; G06T 2207/10016; G06T 2207/10048; G06T 2207/10132

(57) ABSTRACT

An automated method of measuring, monitoring and recording candle burn performance using vision system automation. The method includes timed candle flame height measurement consisting of a camera using image bursts. Recording in a database with a unique identifier barcode for each candle and corresponding wick to identify and record candle data with a date and time stamp. Audio-Visual alerts for flame callouts less than ½ inch or greater than 2 inches and 3″. Documenting any extinguished candles/wicks (mid and/or end of life). Candle Temperature Measurement is performed every 2 hours (depending on burn type and cycle), which includes wax melt pool temperature (with callouts for temperatures reaching and/or exceeding 250 deg C.) and container side wall temperature. Candle Picture is performed at the mid and end of life, and the sustainer position is tracked to determine wick migration.

### FIELD OF THE INVENTION

This invention is directed to the field of candle burn performance and, in particular, to an automated method of measuring, monitoring, and recording candle burn performance.

### BACKGROUND OF THE INVENTION

Candle manufacturing can be considered part science and part artistic expression. In general, a filled candle is manufactured by lowering the temperature of a wax to place it in a liquefied state. The wax may be paraffin, soy, beeswax, or the like. Once the wax is liquefied, fragrance and color may be added to provide visual appeal and a selected scent. Using a mold, a wick coupled to a sustainer is centrally positioned (one wick candle) or strategically positioned (multiple wick candles) in position before the liquefied wax is poured into the mold. The cooling of the wax leads to a finished candle that is removed from the mold and placed within a candle holder.

While candle manufacturing and use thereof appears simple, it is deceptively complicated. The chemical reaction of a candle involves the use of wax as a fuel that is vaporized by a flame to produce a continuous light, heat source, and expulsion of a fragrance. In operation, the lighting of a wick produces a flame which heats up a small amount of wax around the wick. The wick creates a capillary flow of melted wax through the exposed wick, drawing the wax through the wick, wherein the flame converts the wax into a vapor. The vapor combines with oxygen in the air to create a gas. Once the oxygen combines with the vaporized wax, the resulting vapor is ignited by the flame along the tip of the wick, creating a combustion process that will continue as long as there is wax that can be drawn through the wick to provide fuel. The wax, which is a hydrocarbon, uses the flame to react with oxygen to produce water and carbon dioxide, releasing energy in the form of heat and light. The carbon particles released during combustion create a visible flame. The bright part of the flame is where the combustion is taking place. The dimmer, outer part of the flame is where unburned carbon particles are glowing.

The length of a candle wick is adjusted to control the height of the flame. A tall wick allows more wax to be drawn into the wick, providing a higher amount of fuel to the flame. This results in a taller flame because of the additional fuel presented to the flame. If the wick is too long, it may produce a large, flickering flame that may be too hot for the candle container and/or other defects such as wick curling, which may lead to double-wicking, double-flame, etc. Conversely, a smaller wick presents less wax drawn through the wick. If the wick is too short, the flame will be small and will not burn efficiently.

Candles are a fuel source and most countries require manufacturers to perform quality checks to ensure the candles meet certain safety standards. This may include visual inspections, fragrance testing, and most importantly, burn testing. By conducting burn tests, candle manufacturers can optimize their formulations and wick choices to create candles that burn efficiently, have a desirable appearance, and meet safety standards. For instance, random sampling is a quality control technique wherein a subset of candles from a larger source of candles are isolated for inspection and testing. The key principle is that every candle in the population has an equal chance of being selected. This helps ensure that the candle selected is representative of the entire population and reduces bias in the selection process. When using statistical methods for quality control, random sampling allows for the application of statistical tests and calculations with greater confidence, especially since the candle burn tests are performed at various stages, for instance development, pre-screening and post-production burn testing. The results obtained from the sample can be more reliably generalized to the entire population. The larger the sampling, the more accurate the statistical analysis becomes. However, the more candles that are tested, the more manpower is needed.

Candles need to be tested to assure they are safe for use by the general public. To this end, industry standards have been set that manufacturers must adhere too. For instance, in the United States there are ASTM (American Society for Testing and Materials) standards to ensure candle safety, quality, and performance.

ASTM F2058—Standard Test Method for Determining the Luminance of a Fluorescent Source is used to measure the luminance of candles and determining the brightness of fluorescent candles.

ASTM F2326—Standard Test Method for Shipboard Use provides a method for testing candles, primarily focusing on their safety and stability on a ship.

ASTM F2417—Standard Test Method for Fire Safety Evaluation of Candles is used to assess the fire safety performance of candles, including their ignition resistance and flame spread characteristics.

ASTM F2601—Standard Test Method for Residues in Liquids Removed from Candles is used to determine the amount of residue that remains in the liquid that is removed from a burning candle.

ASTM F2399—Standard Test Method for Measuring Candle Holder Heat Resistance evaluates the heat resistance of candle holders to ensure they can withstand the heat generated by the burning candle without melting or deforming.

ASTM F2418—Standard Guide for Candle Fire Safety Information provides information on candle fire safety, labeling, and user instructions to reduce the risk of candle-related fires.

ASTM F2419—Standard Test Method for Measuring Heat of Combustion is used to understand the energy output and burn time of a candle.

ASTM F2600—Standard Test Method for Soot Collecting Properties of Candle Flames measures the amount of soot produced by a candle during its burning. Excessive soot production can be undesirable for both safety and aesthetic reasons.

While random sampling and manual examination of candles for burn testing is standard in the industry, due to the manual labor involved, the quantity of random sampling is reduced making the testing less representative of an entire batch. Testing may include manual observation of a candle burn to observe: Flame Size and Stability—wherein the ideal flame is usually steady, not flickering excessively, and of a moderate size; Wax Consumption—wherein an observation of how quickly or slowly the wax is consumed can provide insights into the candle's burn time and overall efficiency; Flame height—wherein a present manual measure of the flame height using a regular steel scale gives a rather approximate estimate of the maximum flame height; Melt pool temperature—wherein a hand-held temperature probe provides insight into the wax melt pool temperature; Soot—wherein an observation of soot may indicate the wick is too long and the wax traveling up the wick not burning thoroughly enough; Dripping—wherein an observation of dripping may indicate an improper wax type and/or the presence of additives. Melt Pool—wherein the liquid wax around the wick is observed as the candle burns to determine if the melt pool reaches the edges of the candle container or otherwise forms evenly.

What is lacking in the industry is an automated method of evaluating candle burn performance, wherein the present-day variables that impart inaccuracy to the prior art method of manual measurements for flame height and melt pool temperatures are eliminated.

### SUMMARY OF THE INVENTION

A method of measuring, monitoring and recording candle burn performance using vision system and automation. In one embodiment, the method includes candle flame height measurement performed using a timing element for actuating a camera to document the trend of flame height. The method employs an automated database for recording all measurements taken by assigning a unique identifier barcode for each candle and also each candle batch, recording corresponding wick and candle data with a date and time stamp. Audio-Visual alerts for flame callouts less than ½ inch and/or greater than 2 inches and 3″ are provided (different alerts for the high flame heights-warning alert at 2″ flame height and termination alert at 3″ flame height). Documenting any extinguished candles/wicks (middle and/or end of life). Candle Temperature Measurement is performed, together with wax melt pool temperature and container side wall temperature, with callouts for melt pool temperatures reaching and/or exceeding 250 deg C. Candle picture is performed during and at the end of the candle's life, for flame heights and for the sustainer position, to track and determine burn performance and any wick migration.

Custom Racking is further disclosed, one embodiment of which employs an integrated track for the vision system mounted at the end of a 6-axis collaborative robot (cobot). Yet another embodiment could take the form of a monorail mounted vision system for candle burn performance measurement. A three level high and three candle wide×50 ft. length rack is preferred for the current layout, with a track on one side for X-axis movement along each racking. VFD controlled (soft start and stop) feature to minimize air movement during measurement travel. Furthermore, the set-up is designed to allow for vertical movement along the Y-axis, for the robot end-of-arm tooling accessibility to each level of the racking. A high-resolution camera with appropriate filter is employed for flame readings. The cobot system has a park/home position at end of racking, for between readings. Human Machine Interface provided through a wall mount screen and also an ipad with touch screen capability.

An objective of the invention is to provide an automated guided vision system for a candle burn-lab application, with the unitary result of automated measurement, monitoring and recording of burn performance data.

Still another objective of the invention is to provide an automated testing system that provides accurate and precise measurements of candle burn performance, which is otherwise impossible using the prior art conventional methods of handheld scales, probes, etc.

Another objective of the invention is to reduce manual labor in a hazardous environment and provide higher efficiency of operation.

Yet still another objective of the invention is to teach the use of camera imaging for accurate measurement of a candle flame height thereby which conventionally measured manually by use of a measuring scale/stick.

Another objective of the invention is to provide an automated testing system and method that measures candle flame height on a controlled frequency, measures melt pool and side wall temperatures, checks adherence to required ASTM and Abusive test standards, and records information, readings and images in the database.

An advantage of the disclosed testing device and method is that worker safety is enhanced by removing workers from open flame analysis presently performed manually.

Another advantage of the disclosed testing device is that safety is further enhanced during the auto-measurement cycle, since it has the ability to detect and raise audio-visual alarms for any out-of-specified-range values of height, temperature etc.

Still another advantage of the disclosed testing device and system is the ability to objectively test candles allowing larger testing samples to enhance statistical testing results.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a front plane view of the vision system device;

FIG. 2 is a perspective view of the vision system device;

FIG. 3 is a perspective view of the scan and weigh station;

FIG. 4 depicts a sectional view of two tables each with three shelves

FIG. 5 is a top view of the tables depicted in FIG. 4 with two rows in a burn room;

FIG. 6 depicts a vision system device on the end of a cobot arm;

FIG. 7 depicts an end of life image capturing wick sustainer drift;

FIG. 8 is a chart depicting reading guidelines; and

FIG. 9 is a flow diagram of the automated method of evaluating candle burn performance.

### DETAILED DESCRIPTION OF THE PREFERRED EMBODIMENT

Detailed embodiments of the Applicant's invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the Applicant's invention in virtually any appropriately detailed structure.

The automated method of evaluating candle burn performance can be based on a few candles but for proper statistical analysis a group of candles is evaluated. In one embodiment a three level racking is employed. In this embodiment a first shelf is positioned 8″ from the ground level and additional shelves are placed at a levels of 22″ from the 1st shelf to a 2nd shelf, and 22″ from the 2nd shelf to a 3rd shelf. The shelves provide candle spacing of about 8″ from wall-to-wall in both directions using an open lattice construction. In a preferred embodiment wood blocks are used for candle placement on the lattice construction, preferably 5.5″×5.5″ with a thickness of 0.5″.

In a standard testing room the candles are arranged in layers, preferably 3 candles across and 50 candles long.

Human Machine Interface (HMI) employs a computer program illustrating a burn room racking layout with a selection menu for an automated system used for candle measurements. In one embodiment, the automated system is based on the movement of a measuring device that is moved along X-Y-Z planes for proper positioning of the measuring device. The movement can be by rails or more commonly known as a robotic movement. In a preferred embodiment, the robot is a collaborative robot, or cobot, which is constructed and arranged to work alongside humans in a shared workspace. Cobots are built with sensors and safety features that allow the robots to interact safely where individual workers may be present. In either event, a robot like device will position a vision detection system to each candle to perform a range of tasks, both simple repetitive tasks and more complex operations, with a high degree of accuracy, precision and repeatability, while storing the data and images for referencing, evaluation and analysis. Since the cobot is intended to collaborate with human workers, the candles can be changed out as necessary wherein the cobot will work around the human thereby enhancing efficiency and productivity. A cobot prioritizes safety, often including features like force-limiting technology and sensors that enable the cobot to stop or slow down if a human is in their workspace. In addition, further safety measures include area scanners, travel lights and audio-visual alarms.

Measurement steps include selecting either an ASTM or ABUSIVE burn. For example, regarding ASTM burns there can be cycles: 1st cycle: ½ an hour reading, then 2 hr. and 4 hr. mark. Subsequent cycles: 2 hr. and 4 hr. mark only. For example, regarding ABUSIVE: 4 hr. and 8 hr. mark only, each cycle Alert: Call outs on flame heights, less than ½ inches or greater than 2 inches and 3″. Alert: Call out for SE (self-extinguished flame). ALERT call out for flash over.

In the preferred embodiment, the candle is measured every 2 hours with call outs on flame heights less than ½ inch or greater than 2 inches and 3″. Call out is made for a self-extinguished flame and an ALERT call out for a flash over. Audio-visual alarm/alerts can be used for call outs.

Further testing including performing flame height measurement, image bursts (or long exposure averaging in other embodiments); Obtaining a side wall temperature measurement of each candle using a temperature infra-red (IR) sensor; Obtaining a melt pool temperature measurement using a K type thermometer dipping in the center of a 3 wick candle or between a wick and a wall surface for a single wick candle, dipping to a depth of precisely ½ inch, and designed to have a cleaning cycle to avoid any candle-to-candle cross contamination. Audio-visual alerts are provided to callout melt pool temperatures reaching and/or exceeding 250 deg C.

The system captures an image for the end-of-life burn, the photo is taken from the top of the candle showing sustainer position and superimposed circle rings showing allowable +/−⅛″ tolerance on sustainer drift.

In a preferred embodiment, the measuring/monitoring/recording of candle burn performance using vision system placed on the end of the robot arm wherein the vision system includes measurements currently performed manually. Each automated method allows for a faster and more accurate test. For instance, candle flame measurement is conventionally performed manually, wherein a human measures a flame using a metal ruler. Not only is this subjective to the human, it is inaccurate due to inevitable hand movement and it also presents a significant safety hazard due to proximity to the flame. The same applies to melt-pool temperature measurement as well, and the advantages that this invention brings. The automation system employs a vision system and automation to inspect candles using cameras, image processing software, and includes machine learning algorithms to replicate human vision to inspect, guide, and automate the inspection. The base automation comprises the steps of:

Measuring Candle Flame Height with a Frequency of every 2 hours (depending on burn type and cycle), capturing 5 bursts of pictures at each wick (even on a 3-wick candle).

Provide audio-visual alerts for: any flame callouts less than ½ inch; any flame callouts greater than 2 inches and 3″; and any extinguished candles/wicks (mid and/or end of life).

Obtain candle temperature measurement at a frequency of every 2 hours (depending on burn type and cycle); obtain wax melt pool temperature; obtain container side wall temperature.

Photograph the top and plan view of each candle, frequency being the end of life to determine sustainer position for wick migration.

The robot is placed within custom racking having an integrated track for the vision system, mounted at the end of a 6-axis collaborative robot (cobot). The rack is preferably three levels high and three candle wide×50 ft. length (approx.), with a track on one side for X-axis movement along each racking. Furthermore, the set-up is designed to allow for vertical movement along the Y-axis, for the robot end-of-arm tooling accessibility to each level of the racking.

The robot is VFD controlled (soft start and stop) feature to minimize air movement during measurement travel. A high-resolution camera with appropriate filter is employed for flame readings. The cobot system has a park/home position at end of racking, for between readings.

HMI (Human Machine Interface): The main HMI screen provides an entire burn-lab layout. Sub-screens detail candle batch entry and also candle flame height & temperature measurements including burn/post-burn data.

In a preferred embodiment the method of testing is performed in a burn test lab or burn room wherein the room has a regulated temperature of 68-85 deg F. (20-29.5 deg C.). A constant airflow of less than 35 cu ft per minute is maintained at the candle level, with a stipulated minimum of 6 air exchanges per hour within the room.

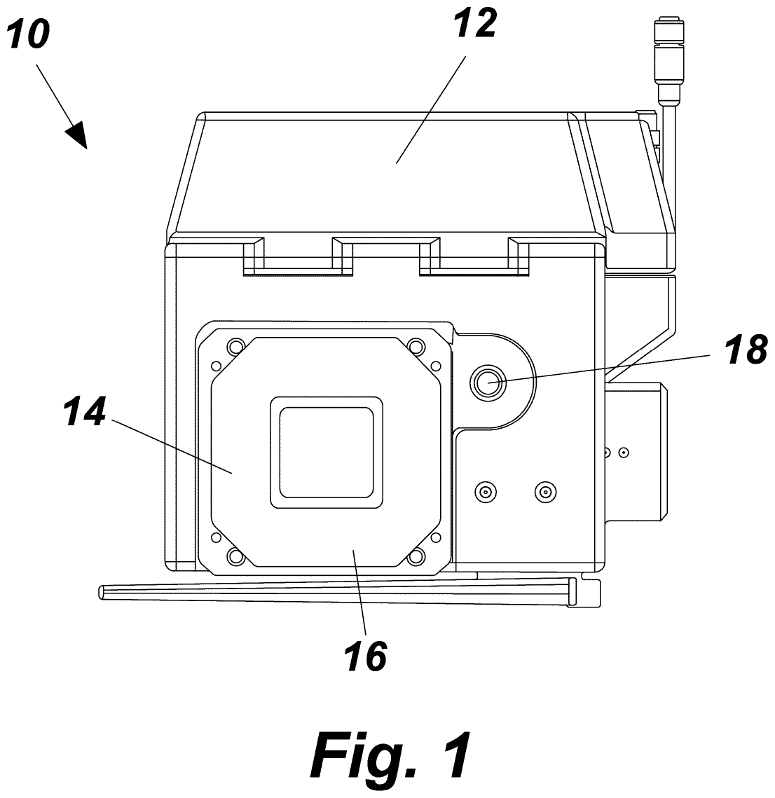

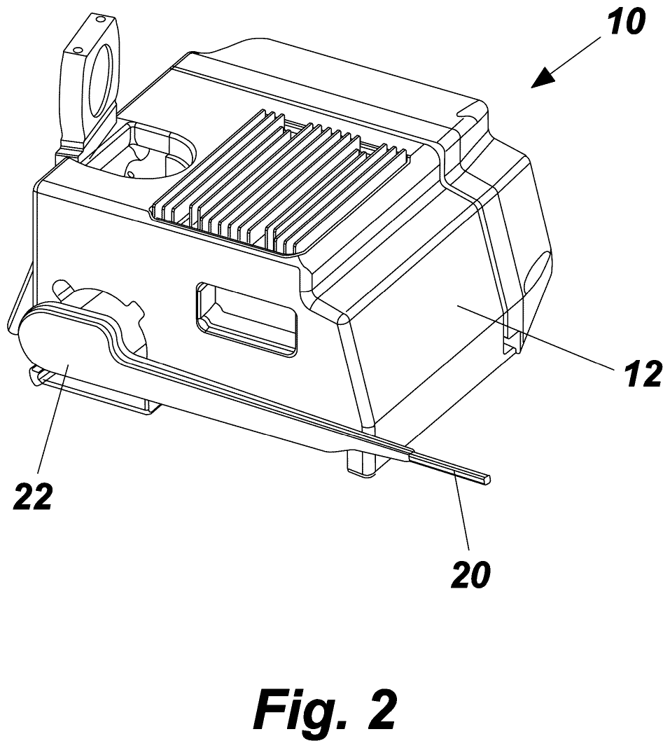

Now referring to the Figures, and specifically FIGS. 1 and 2, a vision system device 10 for measuring, monitoring and recording candle burn performance is shown. The device 10 includes a vision housing 12 constructed of a fire retardant material, such as a fire retardant carbon fiber casing. The housing 12 has a camera 14 incorporated that is constructed and arranged to take a series of images. Images are taken by the camera 14 equipped with auto-focus and an appropriate filter for flame readings. In a preferred embodiment, a plurality of lights 16 positioned around the peripheral of the camera 14 is employed to optimally enhance the images. Images from the camera 14 are then sent for post-processing via a microprocessor and a memory bank coupled to the camera 14. Flame height calculations are facilitated with the aid of pixels mapped over a graduated virtual scale. In addition, the distance, angle of measurement and wax height measurements (using an independent ultrasonic sensor in this embodiment), all play pivotal roles in accurate flame height readings and calculations. In a preferred embodiment, candle flame height measurement is performed every 2 hours (dependent on the burn type and burn cycle), consisting of 25 bursts of pictures for each candle wick. Measurements are recorded in a computer based database using predefined templates.

Further, the vision system device 10 includes an infra red temperature sensor 18 to measure candle side wall temperature and a thermocouple 20 secured within the housing 12 with a swivel coupling 22. The thermocouple 20 is used to measure the candle melt pool temperature. The candle wax melt pool temperature and candle side wall temperature are also measured and recorded every 2 hours, dependent on the burn type and burn cycle. The vision system device 10 being positioned by the collaborative robotic arm and physically moved during the process to position the camera 14 at individual candles to be measured. The movement is conducted via a robot 50 programmable to move the vision system device 10 along the X, Y and Z axis to the position of each candle to be tested.

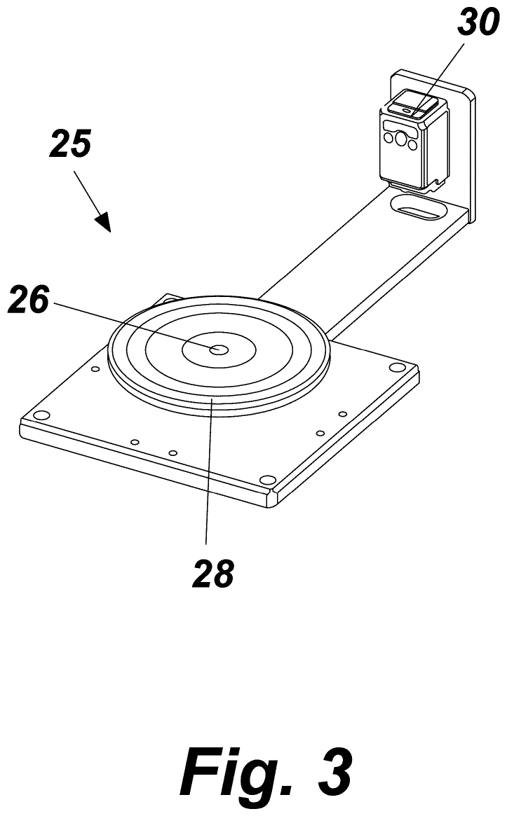

As shown in FIG. 3, the candles to be measured are placed on a scan & weigh station 25 where each individual candle is placed on a load cell 26 having a mount plate 28 where it is then weighed, and the data is further recorded to a computer system. To keep track of each candle individually, the candles have a distinct bar code with a bar code serial number attached to the side wall of the candle. A bar code scanner 30 is used to read the distinct bar code of the candle while it remains on the load cell 26 and it is then corresponded to individual data on a computer system.

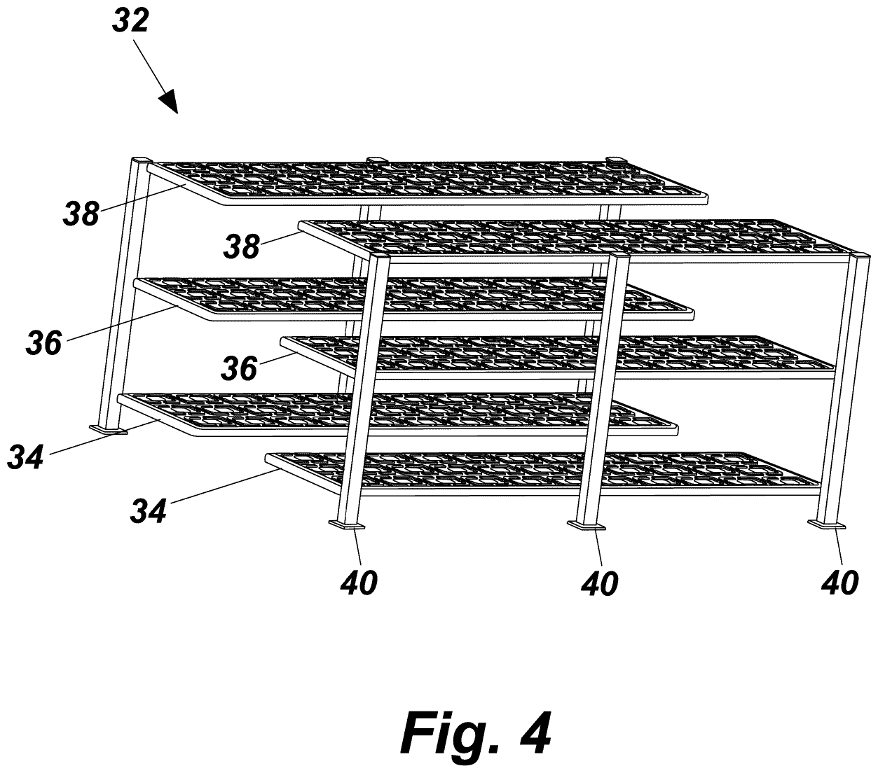

FIG. 4 discloses a section of the racking framework 32 to space candles to be measured apart from one another. In one embodiment a cantilever three level racking is employed where a first shelf 34 is positioned 8″ from the ground level and additional shelves are placed at a level of 22″ from the first shelf to a second shelf 36, and 22″ from the second shelf to a third shelf 38 by a plurality of upright posts 40. The racking framework 32 is designed to facilitate access for the robot 50 to travel in a programmed X, Y and Z axis and properly take measurements of each candle along the framework 32. In a preferred embodiment, the candles are spaced 8″ from container wall-to-wall in both directions.

The first shelf 34, second shelf 36, and third shelf 38 are ideally welded steel frames that are laser cut sheet metal shelf panels and are powder coated. The shelves are further cut by a CNC process to provide a smooth finish, with an open-lattice design for better air flow. The cut-outs are not only designed to be self-locating position holders to receive the wood block base upon which the candle is placed for burn testing, but also serve as coordinate markers for the collaborative robot movement. Proper air flow ensures that the candles burn uniformly, preventing the accumulation of heat and smoke that may distort the test results. The spacing also maintains and ensures a safe and stable environment by providing ventilation.

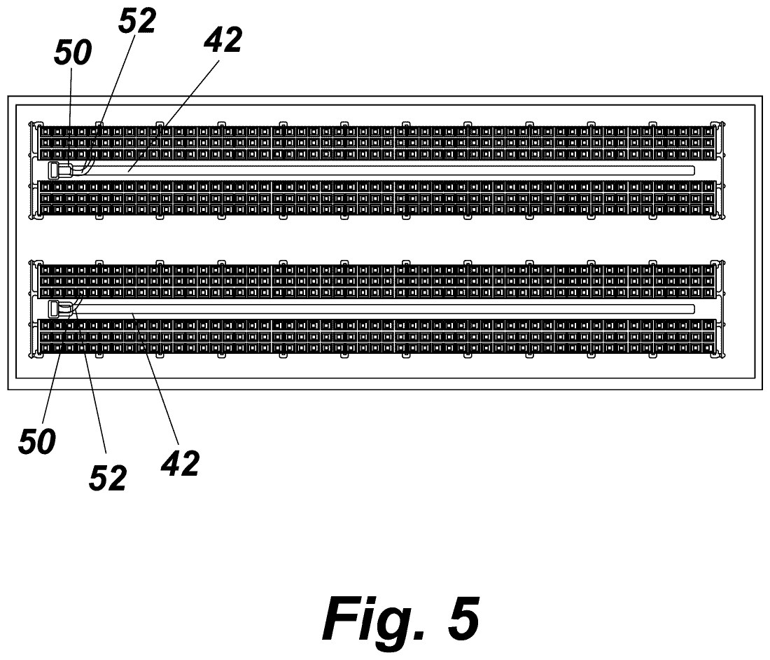

FIG. 5 shows a series of racking frameworks 32 in a shelving configuration found in a burn test lab. In one embodiment, two rows of shelves are parallel to each other and a track 42 is located therebetween. The robot 50 is placed upon and integrated onto the track 42. The track 42 allows for X-axis and Y-axis movement of the robot 50 along each shelf. In a preferred embodiment, the robot 50 has a “Park” or “Home” position at the end of the track 42. The positioning of the robot 50 is further controlled by an operator, or programmed for repetitive movement along the shelving system, or integrated with machine learning so that the robot 50 knows its location along the track 42. Although movement is in the X-axis and Y-axis directions, the robot 50 may exhibit a tilt necessary for proper measurements of the burn characteristics of the candles, if necessary. By way of example, the shelves are placed adjacent to one another, and the measurement of the multiple rows of shelves longitudinally measures to approx. 50′ within a 65′ workspace. Multiple rows of shelves may be duplicated in this way wherein the robot 50 can work on either row of shelves as it slides along the track 42 and the layout can be designed to suit the configuration of the available room or test lab.

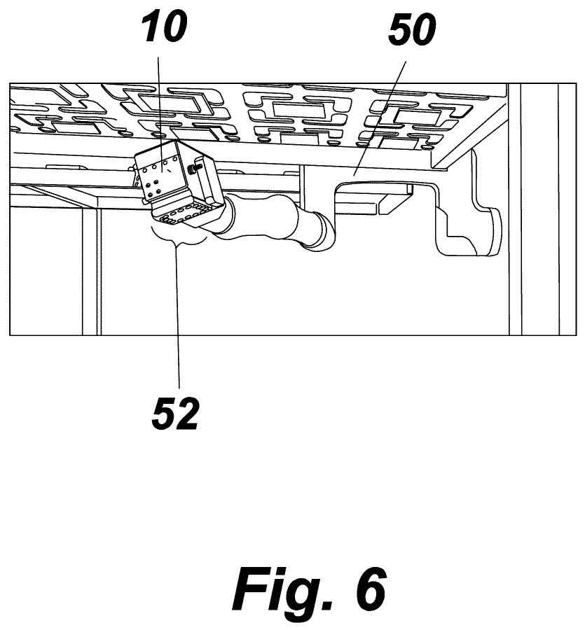

Now referring to FIG. 6, a vision system device 10 is placed on the end of a robot arm. In a preferred embodiment, the robot 50 is a collaborative robot, or cobot, which is constructed and arranged to work alongside humans in a shared workspace. Cobots are built with sensors and safety features that allow the robots to interact safely where individual workers may be present. In either event, a robot like device will position a vision detection system 10 to each candle to perform a range of tasks, both simple repetitive tasks and more complex operations. FIG. 6 shows a robot 50 maneuvering a vision system device 10 around a series of candles placed within the shelves of a racking framework 32 at the end of the robot arm. In a preferred embodiment, the robot 50 has a robotic arm to move the vision system device 10, thermocouples 20 and the like measuring devices.

Once the candle batch has been weighed and scanned and data is logged by the system, the “technician is prompted to select “Get Candle Location” on the HMI screen. The system is designed to auto-select candle placement based on burn test type, for an optimally balanced candle distribution, keeping in mind the robot workload, balanced heat output and minimal distance of travel for maximum efficiency. The HMI screen shows candle location by “FLASHING GREEN” at the intended location for the candle to be placed. Once the candle is placed there and lit, the technician will confirm by selecting “All candles Lit” for that batch, on the HMI screen. The main screen then represents a candle in the ongoing “burn cycle” by a “STEADY GREEN” light at each such candle location.

At the appropriate pre-programmed read pattern timing, the robot arm 52 travels along the X and Y axes, and is able to bring the vision system device 10 to the appropriate location of each candle. Prior to each read, the vision system mounted at the end-of-arm tooling scans the candle barcode as an added verification of the correct candle in the location being measured, as also a top-down image of the candle to ascertain the exact position of the candle on the wood block. Realtime data such as status, visual inspection, and burn & post-burn data can be entered/viewed by the burn room technician on the HMI screen. The robot 50 is able to bring the device 10 into the proper position for the infra red temperature sensor 18 to measure the side wall temperature and for the thermocouple 20 on a swivel connection 22 to measure the melt pool temperature. Further, the Hi-resolution vision system device 10 with auto-focus and filters captures the flames in bursts of images in order to arrive at the max and/or max/average reading. Call outs will occur either with audio or visual indicators for alerts of self-extinguished flames, high flames, flash over, high melt pool temperatures, etc. beyond pre-determined values. The HMI screen will indicate these callouts with “FLASHING RED” at those candle positions.

Once a candle reaches the end time of its stipulated burn cycle, based on the start time triggered upon entry, the HMI screen will show those candle locations as “FLASHING BLUE” for the candle to be blown out for the “Off-cycle”. Once the candles are blown out and the technician confirms this by selecting “All candles Off” on the HMI screen for that batch, the candle main screen then represents a candle in the ongoing “Off cycle” state by a “STEADY BLUE” light at each such candle location.

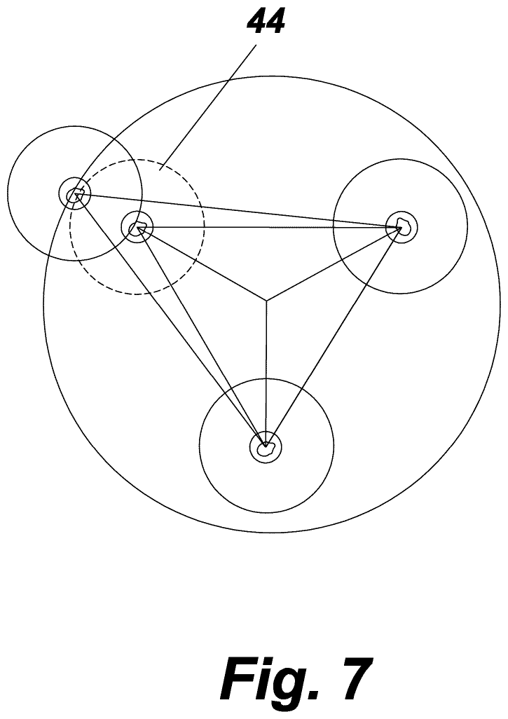

Now referring to FIG. 7, the camera 14 has an appropriate filter to capture 3 wick candle imaging at the end-of-life of the candle wick to capture the shift in wick sustainer 44 position (if any). In case of movement detected beyond any range specified (e.g., 10 mm) then the sustainer 44 position circle will change to red with an alert and can be identified by the burn room technician. The system typically has a built-in tolerance of +/−⅛″ on detecting the sustainer 44 migration.

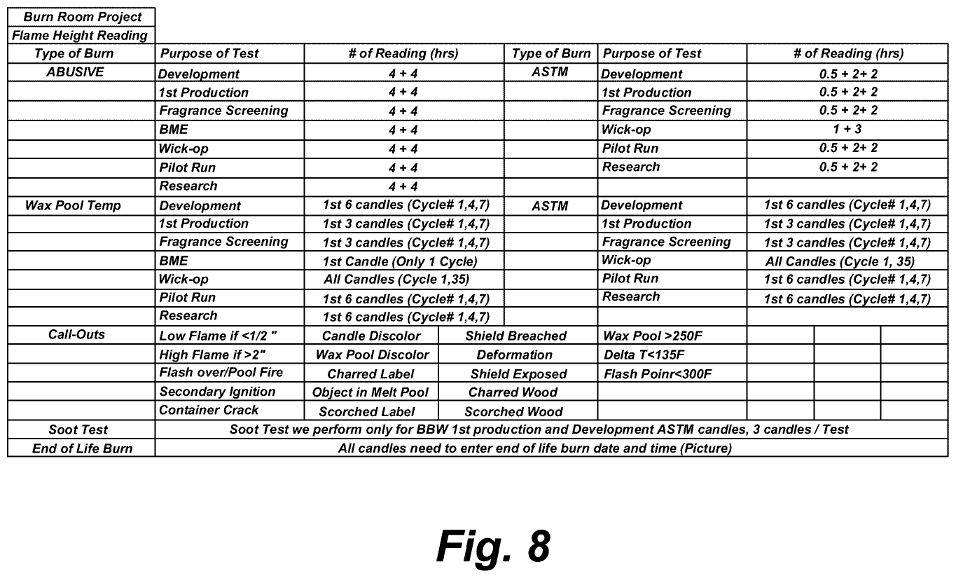

FIG. 8 shows an example of some burn test parameters. Tests are developed based on ASTM or ABUSIVE standards and parameters are set and programmed to run. For example, regarding ASTM burns there can be cycles: 1st cycle: ½ an hour reading, then 2 hr. and 4 hr. mark. Subsequent cycles: 2 hr. and 4 hr. mark only. For example, regarding ABUSIVE: 4 hr. and 8 hr. mark only, each cycle. Alerts and thresholds may also be set to alert the burn room technician of any parameters out of the range set. For example, a burn room technician will be notified of a low flame if the flame's length is less than ½″.

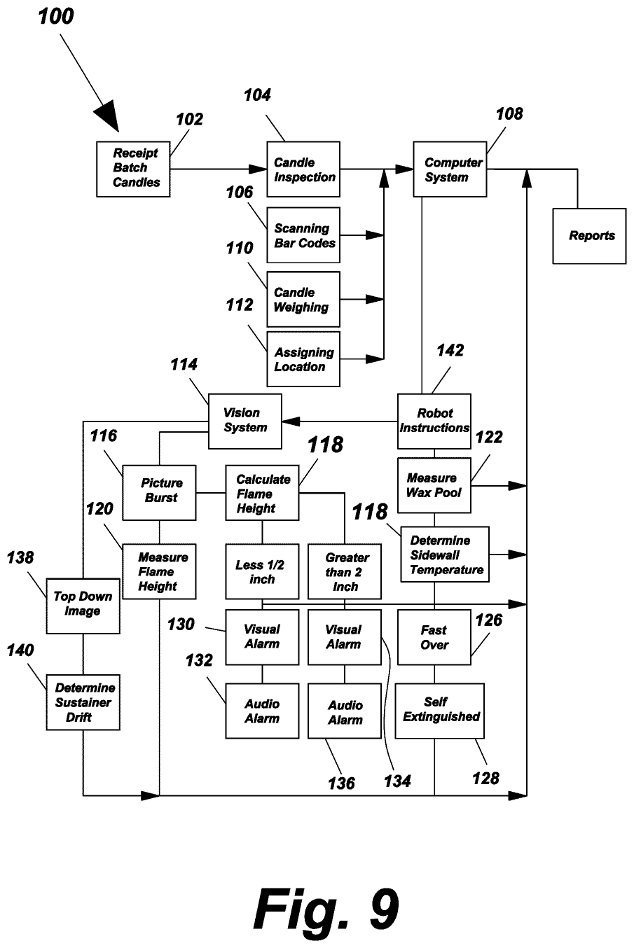

Referring to FIG. 9, depicted is an automated candle testing system 100 for measuring, monitoring, and recording candle burn performance comprising the steps of:
Receiving a batch of candles 102;
Visually inspecting each candle for defects including cracks, imperfections, and debris 104;
Scanning a bar code secured to each candle containing predefined candle data and corresponding wick in order to identify each candle, while simultaneously auto-recording the candle weight 110 from the calibrated load cell coupled to the computer system 106;
Configuring a computer system having a display to receive the predefined candle data for each candle and auto populating a template with the predefined candle data 10. As is common in the industry each candle is weighed before and after a burn cycle. In the preferred embodiment a load cell is used for comparison of pre-burn weight with post-burn weight data for data input into said computer system;
Getting the optimal candle location from the system, candle placement and lighting the candle to initiate the burn cycle physically, while confirming on the HMI screen 112. In a preferred embodiment, the candle is placed on a 5½ inch square wood block having a ½ inch thickness for candle burn testing;
Coupling a vision system device to a placement mechanism capable of movement in the X-Y and Z axis 114, where the placement mechanism receiving instructions from the computer system to systematically visit each candle. The placement mechanism is further defined as a robot having a robot arm configured for movement along the shelves in an X-axis, Y-axis, and Z-axis orientation 142. In a preferred embodiment, the robot is a collaborative robot;
Directing the vision system to record a burst of images of the candle flame 116 and calculating through the computer system the maximum flame heights measured from the burst of images 118 and recording the true length and average height of the maximum flame heights based on pixels mapped to a virtual graduated scale and the camera distance, wax height and angle of inclination 120. In a preferred embodiment, measuring, monitoring, and recording candle burn performance includes taking a series of images 138 wherein the burst of images is each within a few milliseconds. More specifically, a burst of at least 10 images is used to measure flame height as described above. The preferred image burse amount is 25 images;
The steps further comprise the placement mechanism and the vision system positioned over the end of a candle burn life for a top-down image to record sustainer position at the end of burn and illustrate sustainer migration and distance of movement in the top-down image 140;
The steps further comprise displaying a flashing red color on the screen when attention is required at a particular candle location including high flame/flash-over 126/SE, self-extinguished 128, or end of life. In a preferred embodiment, a visual and an audio alert for a safety related fault notifies a burn room technician. Attention is required for a flame height less than ½″ and for a flame height greater than 2 inches and 3″ or a flash-over, self-extinguished flame. For example, a visual alarm 130 and an audio alarm 132 will notify a burn room technician if the flame height is less than 1″, and a visual alarm 134 and an audio alarm 136 will notify a burn room technician if the flame height is greater than 2″ and 3″;
The steps further comprise the vision system measuring candle flame height, performed every 2 hours (dependent on the burn type and burn cycle), consisting of at least 10 bursts of pictures for each candle/wick. Measurements are recorded in a computer based database using predefined templates.

Engaging a thermocouple to measure candle wax melt pool temperature and record the melt pool temperature with the computer system 122;
The steps further comprise the thermocouple checking the center of the wax melt pool for a 2 or 3 wick candle, or multi-wick candle, and the thermocouple checking the wax melt pool between the wick and the candle sidewall for a single wick candle;
The system includes audio-visual alerts for callouts for melt pool temperatures reaching and/or exceeding 250 deg C.

Determining candle sidewall temperature with an Infra-red (IR) sensor and recording the sidewall temperature with the computer system 124;
In one embodiment, the steps further comprise displaying a first color signal through the computer system when a candle is ready to be tested; displaying a second color signal through the computer system when said candle is ready to be extinguished; the computer system indicating when the burn cycle is on and when it is complete through flashing and steady state of the corresponding colors;
Repeating the steps until each candle of a batch is measured, monitored and performance recorded through each pre-determined burn cycle in accordance with the template.

The steps further comprise regulating room temperature used for testing to about 68-85 deg F. (20-29.5 deg C.) with a constant airflow of less than 35 cu ft per minute is maintained at the candle level, with a stipulated minimum of 6 air exchanges per hour within the room.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. An automated method for evaluating candle performance comprising the steps of:
a. receiving a batch of candles;
b. visually inspecting each said candle for defects including cracks, imperfections, and debris;
c. scanning a bar code secured to each candle containing predefined candle data and corresponding wick in order to identify each said candle;
d. configuring a computer system having a display to receive said predefined candle data for each said candle and auto populating a template with said predefined candle data;
e. weighing each said candle on a load cell for comparison of pre-burn weight with post-burn weight data and forwarding weight data to said computer system;
f. auto-populating and recording each candle location on a rack using placement coordinates on said computer system;
g. gauging wax height of each said candle against the predefined candle data on said computer system at each candle read during the burn cycle;
h. coupling a vision system device to a placement mechanism capable of movement in the X-Y and Z axis, said placement mechanism receiving instructions from said computer system to systematically visit each said candle;
i. directing said vision system to record a burst of images of the candle flame and calculating through said vision and computer system the maximum flame heights measured from said burst of images and recording the true length and average height of the maximum flame heights based on pixels mapped over a graduated virtual scale, as well as distance, angle of inclination and wax height;
j. engaging a thermocouple to measure candle wax melt pool temperature and record said melt pool temperature with said computer system;
k. determining candle sidewall temperature with an Infra-red (IR) sensor and record said sidewall temperature with said computer system;
l. repeating steps b-l until each said candle of a batch is measured, monitored and performance recorded in accordance with said template.

2. The automated method for evaluating candle performance according to claim 1 wherein said step of weighing a candle is through a calibrated load cell coupled to said computer.

3. The automated method for evaluating candle performance according to claim 1 wherein said candle is placed on a 5½ inch square wood block having a ½ inch thickness for candle burn testing.

4. The automated method for evaluating candle performance according to claim 1 wherein displaying a flashing red color on said screen when attention is required including low and/or high flames/flash-over/SE, self-extinguished, or end of life.

5. The automated method for evaluating candle performance according to claim 4 including an audio-visual alert for a safety related fault.

6. The automated method for evaluating candle performance according to claim 1 wherein said burst of images is each within a few milliseconds.

7. The automated method for evaluating candle performance according to claim 1 wherein a burst of at least 10 images is used to measure flame height by pixels, distance and angle of measurement.

8. The automated method for evaluating candle performance according to claim 1 wherein said thermocouple checks the melt pool temperature at the center of the wax melt pool for a multi-wick candle.

9. The automated method for evaluating candle performance according to claim 1 wherein said thermocouple checks the temperature of a wax melt pool between the wick and the candle sidewall for a single wick candle.

10. The automated method for evaluating candle performance according to claim 5 wherein said attention is required if the vision system detects a flame less than ½ inch or a flame greater than 2 inch and 3″, or a flash-over, or self-extinguished flame.

11. The automated method for evaluating candle performance according to claim 1 wherein said placement mechanism and said vision system will position over the end of a candle burn life for a top-down image to record sustainer position at the end of burn and illustrate sustainer migration and distance of movement in said top-down image.

12. The automated method for evaluating candle performance according to claim 1 wherein said vision system will measure flame height with a Frequency of every 2 hours dependent on the burn type and burn cycle, capturing 25 bursts of pictures each time at each candle/wick).

13. The automated method for evaluating candle performance according to claim 1 including audio-visual alerts for: any flame callouts less than ½ inch; any flame callouts greater than 2 inch; any flame callouts greater than 3 inch; and any extinguished candles/wicks from mid and/or end of life.

14. The automated method for evaluating candle performance according to claim 1 wherein said placement mechanism is further defined as a robot arm, said robot arm configured for movement along said shelves in an X-axis, Y-axis, and Z-axis orientation.

15. The automated method for evaluating candle performance according to claim 13 wherein robot is a collaborative robot.

16. The automated method for evaluating candle performance according to claim 1 wherein each said candle is placed on a 5½ inch square wood block having a ½ inch thickness for candle burn testing.

17. The automated method for evaluating candle performance according to claim 1 including the steps of: displaying a first color signal through said computer system when a candle is ready to be tested; displaying a second color signal through said computer when said candle is ready to be extinguished; said computer system indicating when said burn cycle is on and when it is complete through flashing and steady state of the corresponding colors.

18. The automated method for evaluating candle performance according to claim 1 including the step of regulating room temperature used for testing to about 68-85 deg F. (20-29.5 deg C.) with a constant airflow of less than 35 cu ft per minute is maintained at the candle level, with a stipulated minimum of 6 air exchanges per hour within the room.

19. A vision system device for measuring, monitoring and recording candle burn performance comprising:
a vision housing constructed of a fire retardant material;
a camera incorporated into said housing, said camera constructed and arranged to take a series of images;
a plurality of lights positioned around the peripheral of said camera to enhance said images;
a microprocessor and memory bank coupled to said camera, and calculating flame height from said images with the aid of pixels mapped over a graduated virtual scale, the distance, angle of measurement and wax height measurements (using an independent ultrasonic sensor in this embodiment, all play pivotal roles in accurate flame height readings and calculations;
an infra red temperature sensor to measure candle side wall temperature;
a thermocouple secured to said housing with a swivel coupling, said thermocouple used to measure candle melt pool temperature; and
a robot having an end of arm tooling for receipt of said vision housing;
wherein said robot is programmable to move said vision system along X, Y and Z axis to the position of each candle to be tested.

20. The vision system device according to claim 19 wherein candle flame height measurement is preformed every 2 hours consisting of 25 bursts of pictures at each candle/wick in this embodiment.

21. The vision system device according to claim 19 wherein candle wax melt pool temperature and candle side wall temperature is measured and recorded every 2 hours (depending on burn type and cycle).

22. The vision system device according to claim 19 wherein measurements are recorded in a computer based database using predefined templates.
